(19) United States
(12) Patent Application Publication
(10) Pub. No.: US 2008/0303626 A1
(43) Pub. Date: Dec. 11, 2008

(54) Fuse For a Chip

(75) Inventors: Werner Blum, Heide (DE); Reiner Friedrich, Heide (DE); Reimer Hinrichs, Heide (DE); Wolfgang Werner, Heide (DE)

Correspondence Address: MCKEE, VOORHEES & SEASE, P.L.C., 801 GRAND AVENUE, SUITE 3200, DES MOINES, IA, 50309-2721, US

(73) Assignee: VISHAY BCcomponents BEYSCHLAG GmbH, Heide (DE)

(21) Appl. No.: 11/571,787

(22) PCT Filed: Jun. 27, 2005
(86) PCT No.: PCT/EP05/06894

§ 371 Date: Jan. 8, 2007

(30) Foreign Application Priority Data
Jul. 8, 2004 (DE) 10 2004 033 251.7

(51) Int. Cl. H01H 85/04; H01H 69/02

(52) U.S. Cl. 337/297; 29/623

(57) ABSTRACT

In order to produce a cost-effective fuse (100) in chip design, which is applied to a carrier substrate (10) made of a Al₂O₃ ceramic having a high thermal conductivity, and which is provided with a fusible metallic conductor (13) and a cover layer (14), in which the melting point of the metallic conductor (13) may be defined reliably, it is suggested that an intermediate layer (11) having low thermal conductivity be positioned between the carrier substrate (10) and the metallic conductor (13), the intermediate layer (11) being formed by a low-melting-point inorganic glass paste applied in the screen-printing method or an organic intermediate layer (11) applied in island printing. Furthermore, a method for manufacturing the fuse (100) is specified.

The present invention relates to a fuse in chip design, which is applied to a carrier substrate made of an Al₂O₃ ceramic, having a fusible metal conductor, which is applied and structured using thin-film technology and is provided with a cover layer, as well as a cost-effective method for manufacturing the chip fuse.

Chip fuses are implemented on a ceramic base material with the aid of methods known to those skilled in the art, such as photolithography. Other carrier materials, such as FR-4 epoxide or polyimide, are also known. Chip fuses are typically designed for a voltage up to 63 V.

In order to avoid damage to other electronic components due to a malfunction in the electrical power supply, which causes over voltage or too large a current flow, providing a fuse in the power supply is known. The fuse essentially comprises a carrier material and a metallic conductor made of copper, aluminium, or silver, for example. The maximum possible current strength which may flow through this conductor without fusing it is determined by the geometry and the cross-section of the conductor. If this value is exceeded, the electrical conductor is fused because of the heat resulting therein due to its electrical resistance and the power supply is thus interrupted before downstream electronic components are overloaded or damaged.

In the methods for manufacturing chip fuses in thick-film technology, in which the fusible element and contact layers are applied as pastes using screen-printing onto a substrate foundation having low thermal conductivity, sufficient precision of the geometry of the fusible element layers may only be implemented inadequately because of the screen-printing method. For high-value thick-layer fuses it is therefore necessary to process the fusible element and/or the fusible metallic conductor through additional laser cutting methods.

Typically, ceramic substrates having a high Al₂O₃ proportion, which have been glazed over the entire surface, or ceramic substrates, which are low in aluminium oxide, having a low thermal conductivity are selected as the substrate foundation. Both types of substrate are significantly more expensive than typical ceramic substrates made of 96% Al₂O₃ in thick-film quality, for example, which are used in manufacturing passive components.

In a method for manufacturing a fuse in thin-film technology, a fusible metallic conductor is applied through electrochemical methods or through sputtering. Especially high precision of the cut-off and/or fusing characteristic is achieved in this case through photolithographic structuring of sputtered layers, a substrate low in aluminium oxide having a low thermal conductivity being used as the foundation.

JP 2003/173728 A discloses a manufacturing method for a chip fuse in thin-film technology, a fuse 14 and a cover layer 15 being positioned on a substrate 11. The fuse 14 is structured using photolithography. The substrate 11 has a low thermal conductivity so that it does not dissipate the heat in the electrical conductor 14 caused by current flowing through the electrical conductor 14 and thus favours fusing of the electrical conductor 14. The electrical conductor 14 is in direct contact with the substrate 11.

JP 2002/140975 A describes a fuse having a metallic conductor 14 made of silver, which is also positioned directly on a substrate 11 having low thermal conductivity, the metallic conductor 14 being electroplated or implemented as a thick layer.

JP 2003/151425 A discloses a fuse having a glass ceramic substrate 11 having a low thermal conductivity and a metallic conductor 14 in thick-film technology.

JP 2002/279883 A also describes a fuse for a chip in which the fusible region 17 of the conductor 15 is manufactured through complex laser processing. This requires additional time-consuming and costly processing steps.

JP 2003/234057 A discloses a fuse resistor having a resistor 30 on a substrate 10, a further heat-storing layer 42 being provided between the resistor 30 and the substrate 10 in order to store the heat arising in the resistor 30. The fusible region is also manufactured through laser processing.

JP 08/102244 A describes a fuse 10 in thick-film technology having a glass-glaze layer 2 having a low thermal conductivity, the glass layer 2 being positioned on a ceramic substrate 1 and a fuse 3 being applied to the glass layer 2.

JP 10/050198 A discloses a further fuse in thin-film technology having a complex layer construction, in which a further elastic silicone layer 6 is implemented on the conductor 3 and a glass layer 5.

DE 197 04 097 A1 describes an electrical fuse element having a fusible conductor in thick-film technology and a carrier, the carrier comprising a material having poor thermal conductivity, particularly a glass ceramic.

DE 695 12 519 T2 discloses a surface-mounted fuse device, a thin-film fusible conductor being positioned on a substrate and the substrate preferably being an FR-4 epoxide or a polyamide.

Therefore, a method is known for manufacturing chip fuses in thick-film technology using special ceramics or even Al₂O₃ ceramics and a thermally insulating intermediate layer, and chip fuses in thin-film technology using special ceramics or other special carrier materials are also known.

It is therefore the object of the present invention to specify a fuse according to the species which may be manufactured cost-effectively and with sufficient precision, its fusing characteristic being able to be defined precisely. Furthermore, a method for manufacturing the fuse is to be specified.

These objects are achieved by the features of Claims 1 and 11.

The core idea of the present invention is to combine the advantages of a cost-effective manufacturing process for passive components with the advantages of thin-film technology and precise photolithographic structuring, which is implemented by using a thermally insulating intermediate layer on Al₂O₃ ceramic in combination with thin-film technology and photolithographic structuring.

The core idea of the present invention thus comprises providing an intermediate layer, between a cost-effective ceramic substrate as a carrier having high thermal conductivity and the actual fusible metallic conductor, which is produced either through a cost-effective method, preferably low-melting-point inorganic glass pastes applied in the island printing method or an organic layer applied in island printing. Because of the low thermal conductivity of this intermediate layer, the heat arising in the metallic conductor due to the current flowing through it is not dissipated downward through the carrier substrate, which typically has a higher thermal conductivity, so that the conductor fuses in the desired way at a defined current strength therein. This intermediate layer is used as the thermal insulator. A low-melting-point inorganic glass paste is preferably used as the intermediate layer, which is particularly applied to the carrier substrate in the screen-printing method. This offers a significant advantage in relation to other substrates having low thermal conductivity, since the latter may be provided and/or manufactured practically only as special productions, while in contrast, through the application of glass islands as the thermally insulating intermediate layer, cost-effective standard ceramics may now be used, even those only having moderate surface composition (thick-film quality) being able to be used. In an alternative embodiment, the intermediate layer is an organic intermediate layer, which is particularly applied in island printing and subsequently baked and/or cured in the way known to those skilled in the art through the effect of heat in the carrier substrate. In this case, through island printing, which is simple to perform, arbitrary shaping of the intermediate layer may also be obtained, and Al₂O₃ ceramics may be used as the carrier material.

The advantage of the present invention is that a cost-effective standard ceramic, a thermally insulating intermediate layer, which may be manufactured cost-effectively in the screen-printing method, having the advantage of thin-film technology, and photolithographic structuring may be combined. In this way, high-precision and cost-effective fuses for safeguarding electronic assemblies from fault currents may be manufactured in miniaturized embodiments. Advantageous embodiments of the present invention are characterized in the subclaims.

An aluminium oxide substrate is advantageously used as the carrier substrate for the fuse, which is available cost-effectively and in any arbitrary shape and size from practically all manufacturers of ceramic substrates of this type and is used, for example, in mass production of resistor manufacturers. Aluminium oxide ceramic substrates of this type may already be provided by the manufacturer with preliminary notches in the shape of the chips to be manufactured later from the substrate. In both of the embodiments described above, the intermediate layers are applied in the region of the preliminary notches predefined by the manufacturer, for example, in order to separate the carrier substrate in a known way without damaging the intermediate layers through fracturing processes during a later isolation process.

In order to improve the adhesion of the metallic conductor to the intermediate layer, an inorganic or an organic adhesion promoter may be applied directly to the intermediate layer in the spray method or through sputtering. In an advantageous embodiment, the metallic conductor is formed by a low-resistance metal layer in order to be able to set the melting point of the fuse precisely.

In a first embodiment, this metal layer is applied to the intermediate layer and/or the adhesion promoter layer through sputtering. If the sputtered metal layer was applied to a carrier substrate glazed over its entire surface, this would lead to reduced adhesion, so that delamination of the metal layer in the pre-contact region could arise during an isolation process using fracturing. By applying the metal layer onto a thermally insulating island in the form of an intermediate layer having low thermal conductivity, good adhesion of the metal layer to the rougher aluminium oxide ceramic is ensured in the contact region, since smooth surfaces are produced by these glass islands in the region of the fuse, through which the photolithographic structuring of the fuse may be performed especially precisely, since in contrast to this, carrier substrates made of ceramics having poor thermal conductivity have higher surface roughness, which is unfavourable for precise photolithographic structuring.

For structuring the metallic conductor into the form of the desired fuse, it is suggested that this be performed through positive or negative lithography. In a positive lithography process, a metal layer, such as copper, is deposited over the entire area onto the layer positioned underneath and the desired structure is subsequently photo lithographically etched into the layer, for example. In a negative lithography process, first a photo resist is deposited, sprayed, for example, onto the layer lying underneath, i.e., the intermediate layer or the adhesion promoter layer, and subsequently photo lithographically structured in the desired way. Subsequently, a metal layer, such as a sputtered copper film, is deposited thereon and the remaining photo resist regions having the metal film thereon are removed.

To protect the fuse, one or more cover layers are applied to cover the metallic conductor or preferably the entire fuse, which may be formed by an inorganic barrier layer, among other things. The organic cover layer is particularly a polyamide, polyimide, or an epoxide, and may also be implemented as multilayered.

For the contacts of the fuse, the end contacts of the metallic conductor are produced through electrode position of a metallic barrier layer, typically made of nickel, and the final layer, which may be soldered or bonded, typically made of tin or tin alloys.

In the following, the present invention will be explained in greater detail on the basis of the drawing.

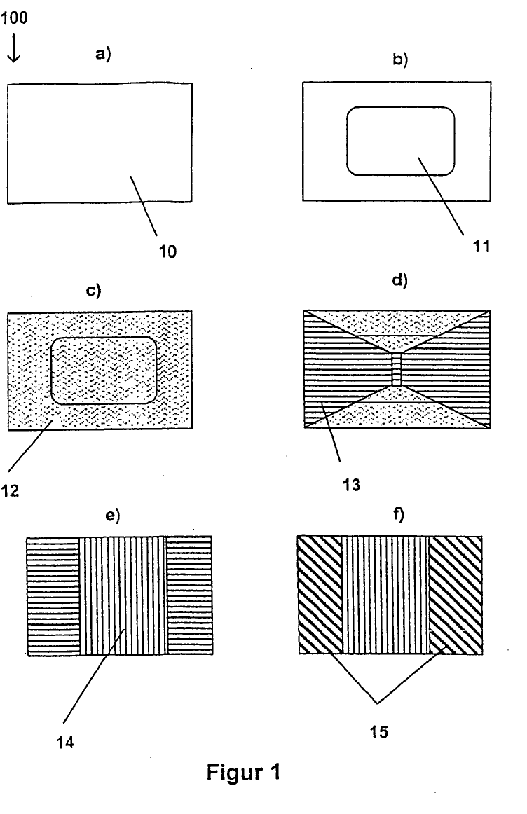

FIG. 1: shows the manufacturing process of a fuse in six steps.

In the manufacturing process of a fuse 100 shown in FIG. 1, first a thermally insulating intermediate layer 11 is deposited in island form (step b)) onto a carrier substrate (step a)), preferably an aluminium oxide ceramic. An adhesive layer 12 for improving the adhesion of the metallic conductor 13 to the foundation is applied (step c)) to this intermediate layer 11 and the surrounding carrier substrate 10. Subsequently, the metallic conductor 13, such as a copper layer which is sputtered on and photo lithographically structured in the desired way (step d)), is applied to the adhesive layer 12.

In this way, through the thickness and width of the web in the central region of the metallic conductor 13, the maximum current strength is predefined, this web fusing if the maximum current strength is exceeded and other electronic components thus being protected from damage. Through the thermally insulating intermediate layer, the heat conduction into the carrier substrate 10 is strongly suppressed, so that the melting point of the fuse 100 may be defined precisely.

Subsequently, the fuse 100 and/or the central region of the metallic conductor 13 is coated with an organic cover layer 14, such as a polyamide or an epoxide, in order to protect the fuse 100 from damage. For the contacts, the end contacts 15 of the metallic conductor 13 are electroplated, using nickel and tin, for example.

### LIST OF REFERENCE NUMBERS

100 fuse
10 carrier substrate
11 intermediate layer
12 adhesive layer
13 metallic conductor
14 cover layer
15 end contact

What is claimed is:

1. A fuse (100) in chip design, which is on a carrier substrate (10) made of a ceramic having a fusible metallic conductor (13) applied and structured using thin-film technology and is provided with a cover layer (14), characterized in that the carrier substrate (10) is an Al₂O₃ ceramic having high thermal conductivity, an intermediate layer (11) having lower thermal conductivity being positioned between the carrier substrate (10) and metallic conductor (13) and the intermediate layer (11) being a low-melting-point inorganic glass paste, preferably applied in the screen printing method, or an organic intermediate layer (11), preferably applied in island printing, and the fusible metallic conductor (13) being applied through sputtering or vapor deposition methods and structured using lithography technology.

2. The fuse according to claim 1,
characterized in that the carrier substrate (10) is an aluminium oxide ceramic in thick-film or thin-film quality.

3. The fuse according to claim 1,
characterized in that an adhesive layer (12) is positioned on the intermediate layer (11).

4. The fuse according to claim 1,
characterized in that the metallic conductor (13) is formed by a low-resistance metal layer.

5. The fuse according to claim 1,
characterized in that the metallic conductor (13) is formed by low-resistance Cu, Au, Ag, Sn, or Cu-, Au-, Ag-, Sn-alloys.

6. The fuse according to claim 4,
characterized in that the metal layer is preferably sputtered on in the vacuum method, vapor deposited, or deposited through other physical or chemical methods.

7. The fuse according to claim 1,
characterized in that the metallic conductor (13) is structured using a positive or negative lithography method.

8. The fuse according to claim 1,
characterized in that a cover layer (14) is produced on the metallic conductor (13) by an inorganic and/or organic layer, particularly by a polyamide, polyimide, polyamide imide, or an epoxide, and is particularly implemented as multilayered.

9. The fuse according to claim 1,
characterized in that an inorganic barrier layer is produced between the cover layer (14) and the metallic conductor (13).

10. The fuse according to claim 1,
characterized in that end contacts (15) of the fuse (100) are produced through immersion or preferably through electrode position, particularly of copper, nickel, tin, and tin alloys.

11. A method for manufacturing a fuse (100) in chip design, wherein
an intermediate layer (11) having low thermal conductivity is applied to a carrier substrate (11) made of an Al₂O₃ ceramic having a high thermal conductivity,
the intermediate layer (11) is formed by a low-melting-point inorganic glass paste applied in the screen printing method or an organic intermediate layer (11) applied in island printing,
a metallic conductor (13) is applied to the intermediate layer (11),
a cover layer (14) is applied to the metallic conductor (13).

12. The method according to claim 11,
characterized in that an Al₂O₃ aluminium oxide ceramic in thick-film or thin-film quality is used as the carrier substrate (10).

13. The method according to claim 11,
characterized in that an adhesive layer (12) is applied to the intermediate layer (11).

14. The method according to claim 11,
characterized in that the metallic conductor (13) is formed by a low-resistance metal layer.

15. The method according to claim 14,
characterized in that the metal layer is preferably sputtered on in the vacuum method, vapor deposited, or deposited through other physical or chemical methods.

16. The method according claim 14,
characterized in that the metal layer is formed by low resistance Cu, Au, Ag, Sn, or Cu-, Au-, Ag-, Sn-alloys.

17. The method according to claim 11,
characterized in that the metallic conductor (13) is structured by a positive or negative lithography process.

18. The method according to claim 11,
characterized in that the cover layer (14) is formed by an inorganic and/or organic layer, particularly by a polyamide, polyimide, polyamide imide, or an epoxide, and may also be implemented as multilayered.

19. The method according to claim 11,
characterized in that an inorganic barrier layer is produced between the cover layer (14) and the metallic conductor (13).

20. The method according to claim 11,
characterized in that end contacts (15) of the fuse (100) are formed through immersion or preferably through electroplating, particularly of copper, nickel, tin, or tin alloys.
